(19) United States
(12) Patent Application Publication
(10) Pub. No.: US 2017/0361434 A1
(43) Pub. Date: Dec. 21, 2017

(54) RATCHET WRENCH HAVING POSITIONING MECHANISM

(71) Applicant: YIH CHENG FACTORY CO., LTD., Nantuo (TW)

(72) Inventor: Chih-Hung CHIEN, Nantuo (TW)

(21) Appl. No.: 15/185,069

(22) Filed: Jun. 17, 2016

(51) Int. Cl. B25B 23/00; B25B 13/48; B25B 13/46

(52) U.S. Cl. CPC B25B 23/0028; B25B 13/461; B25B 13/481

(57) ABSTRACT

A ratchet wrench having a positioning mechanism includes a drive bar, a rotary head, and a locking button. The drive bar includes a fork arm, an axial hole communicating with the fork opening, and a radial hole communicating with the axial hole. The rotary head is pivotally connected to two ends of the fork arm; the rotary head includes a round housing, a plurality of positioning recesses disposed on the round housing, and a pivot axis passing through rotary head. The pivot axis is perpendicular to the radial hole. The locking button includes a locking rod disposed in the radial hole and a latch bar disposed in the axial hole. The locking rod is radially movable in association with movement of the latch bar, and the latch bar is engaged with or disengaged from any of the positioning recesses.

### TECHNICAL FIELD

The present invention relates to a ratchet wrench and, in particular, to a ratchet wrench having a positioning mechanism, whereby a rotary head is free to rotate by some certain angles and can be fastened quickly in a radial direction.

### BACKGROUND

The ratchet wrench is a common hand tool for tightening operations. The ratchet wrench can be used flexibly and can move back and forth freely to tighten or loosen blots, nuts, or the likes, so it replaces a traditional wrench in many situations.

The ratchet wrench includes a head portion, a bar extending outwardly from the head portion, and a drive head disposed on the head portion. The drive head is drivingly associated with objects, e.g. nuts and bolts, by means of a variety of sleeves in different sizes. A user simply needs to hold the bar to swing it, and the objects can be loosened or tightened. However, the conventional ratchet wrench is often limited by a dead corner or a tiny space, and thereby the drive head of the ratchet wrench cannot fasten the objects smoothly. In solution, there is a ratchet wrench with a drive head rotatable with respect to the bar. However, the ratchet wrench with the rotatable drive head has a complicated structure for fixing the drive head, and its inconvenient operations cannot meet the market's expectations.

### SUMMARY

It is an object of the present invention to provide a ratchet wrench with a positioning structure, whereby a rotary head can be fastened or released quickly by radially pushing a locking button.

Accordingly, the present invention provides a ratchet wrench with a positioning structure, comprising a drive bar, a rotary head and a locking button. The drive bar includes a fork arm, a fork opening formed at the fork arm, an axial hole communicating with the fork opening, and a radial hole communicating with the axial hole. The rotary head is pivotally connected to two ends of the fork arm, the rotary head includes a round housing, a ratchet apparatus disposed inside the round housing, a plurality of positioning recesses disposed on the round housing, and a pivot axis passing through the rotary head and the two ends of the fork arm, wherein the pivot axis is perpendicular to the radial hole. The locking button includes a locking rod disposed in the radial hole and a latch bar disposed in the axial hole. The locking rod is radially movable in association with movement of the latch bar, and the latch bar is engaged with or released from any of the positioning recesses.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective view according to a first embodiment of the present invention;

FIG. 2 is a partial cross-sectional view according to the first embodiment of the present invention;

FIG. 3 is another perspective view according to the first embodiment of the present invention;

FIG. 4 is a partial cross-sectional view of FIG. 3;

FIG. 5 is still another perspective view according to the first embodiment of the present invention;

FIG. 6 is a partial cross-sectional view of FIG. 5;

FIG. 7 is a cross-sectional view according to a second embodiment of the present invention;

FIG. 8 is another cross-sectional view according to the second embodiment of the present invention;

FIG. 9 is a cross-sectional view according to a third embodiment of the present invention; and

FIG. 10 is another cross-sectional view according to the third embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

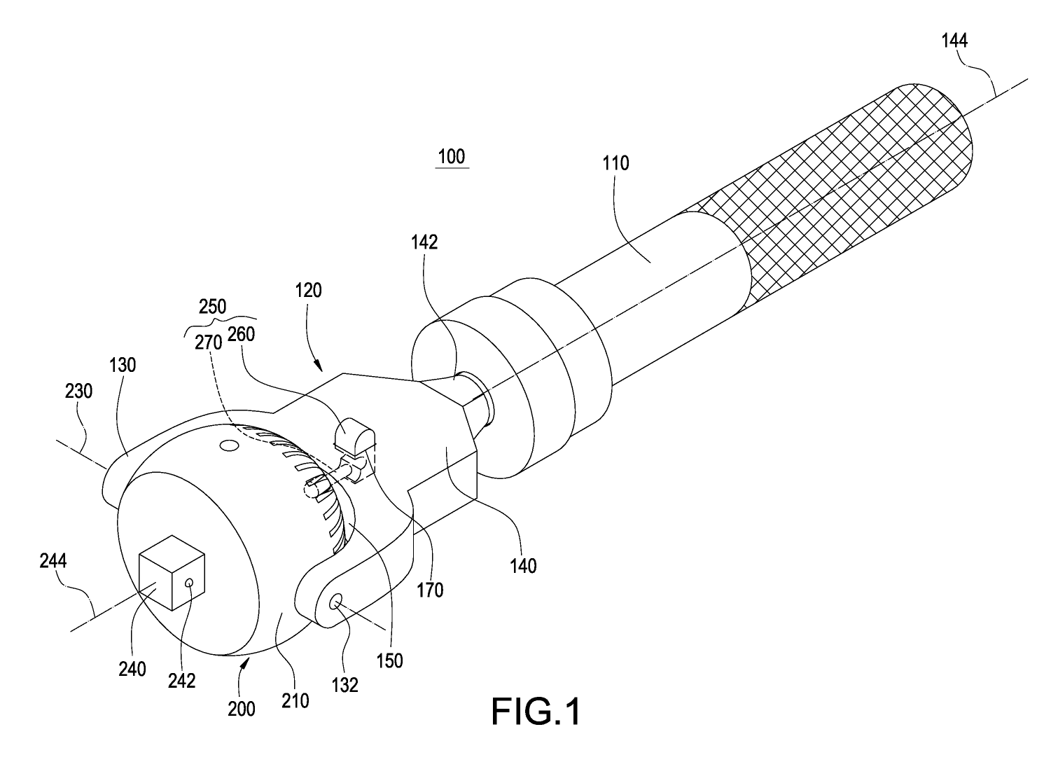

Referring to FIGS. 1 to 4, the present invention provides a ratchet wrench 100 having a positioning mechanism, comprising a drive bar 120, a rotary head 200, and a locking button 250. In the present embodiment, the ratchet wrench 100 preferably includes an operation handle 110 for receiving the drive bar 120. By quickly rotating the operation handle 110 when the ratchet wrench 100 is in an upright state or by moving back and forth the operation handle 110 when the ratchet wrench 100 is in a horizontal state, the rotary head 200 tightens or loosens an object (not illustrated).

The drive bar 120 includes a fork arm 130, a fork opening 150 formed at the fork arm 130, an axial hole 160 communicating with the fork opening 150, and a radial hole 170 communicating with the axial hole 160. The fork arm 130 includes two forks (not labelled); the fork opening 150 is formed between the two forks. The rotary head 200 is pivotally connected to two ends of the fork arm 130. The rotary head 200 includes a round housing 210 and a ratchet apparatus (not illustrated) disposed in the round housing 210, a plurality of positioning recesses 220 disposed on the round housing 210, and a pivot axis 230 located at the rotary head 200 and passing through the two ends of the fork arm 130, wherein the pivot axis 230 is perpendicular to the radial hole 170.

The rotary head 200 further includes an output element 240 in a rectangular shape protruding from one end of the round housing 210, a positioning ball 242 at one side surface of the output element 240, and a ratchet apparatus (not illustrated) connected to the rectangular output element 240. A variety of sleeves (not illustrated) in different sizes can be engagedly assembled to the output element 240 by means of the positioning ball 242 of the output element 240, so as to tighten or loosen the object.

In the present embodiment, the drive bar 120 further includes two supporting bolts 132, an enlarged end 140 and a bar body 142. The supporting bolts 132 are inserted through the two ends of the fork arm 130 respectively and are pivotally connected between the round housing 210 and the fork arm 130. The pivot axis 230 is an imaginary line passing through an axle center of each supporting bolt 132, so that the rotary head 200 is freely rotatable about the pivot axis 230 at the fork opening 150 to certain angles, e.g. from 0 to 270 degrees. The enlarged end 140 is disposed between the fork arm 130 and the bar body 142. A size of the enlarged end 140 is greater than a size of the bar body 142. The axial hole 160 and the radial hole 170 are preferably disposed in the enlarged end 140, and therefore the ratchet wrench 100 of the present embodiment has better strength and provides superior operation quality.

Furthermore, the positioning recesses 220 at least includes a first positioning recess 222 disposed on a top of the round housing 210 and a second positioning recess 224 disposed at each of two opposite sides of the round housing 210. The first positioning recess 222 and the second positioning recess 224 form an included angle of 90 degrees therebetween, so that a user can operate the ratchet wrench 100 in an upright state, i.e. a central axis 244 of the output element 240 is parallel to a rotation axis 144 of the drive bar 120, or alternatively in a horizontal state, i.e. the central axis 244 of the output element 240 is perpendicular to the rotation axis 144 of the drive bar 120. The rotation axis 144 is preferably a central line of the drive bar 120 and/or the operation handle 110.

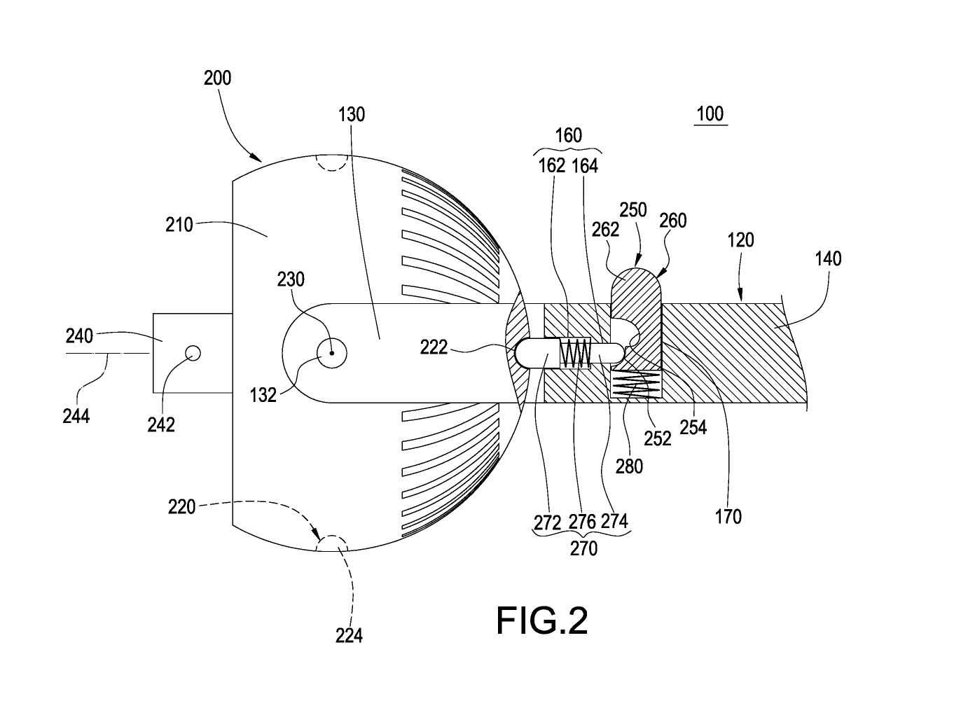

The locking button 250 includes a locking rod 260 disposed in the radial hole 170 and a latch bar 270 disposed in the axial hole 160. The locking rod 260 is radially movable in association with movement of the latch bar 270, so that the latch bar 270 can be engaged with or released from any of the positioning recesses 220. As shown in FIGS. 1 and 2, the locking button 250 includes a locking spring 280 for automatically restoring the locking rod 260, and the latch bar 270 axially move at the same time to protrude out of the axial hole 160. At this moment, the ratchet wrench 100 is in a locked state/position.

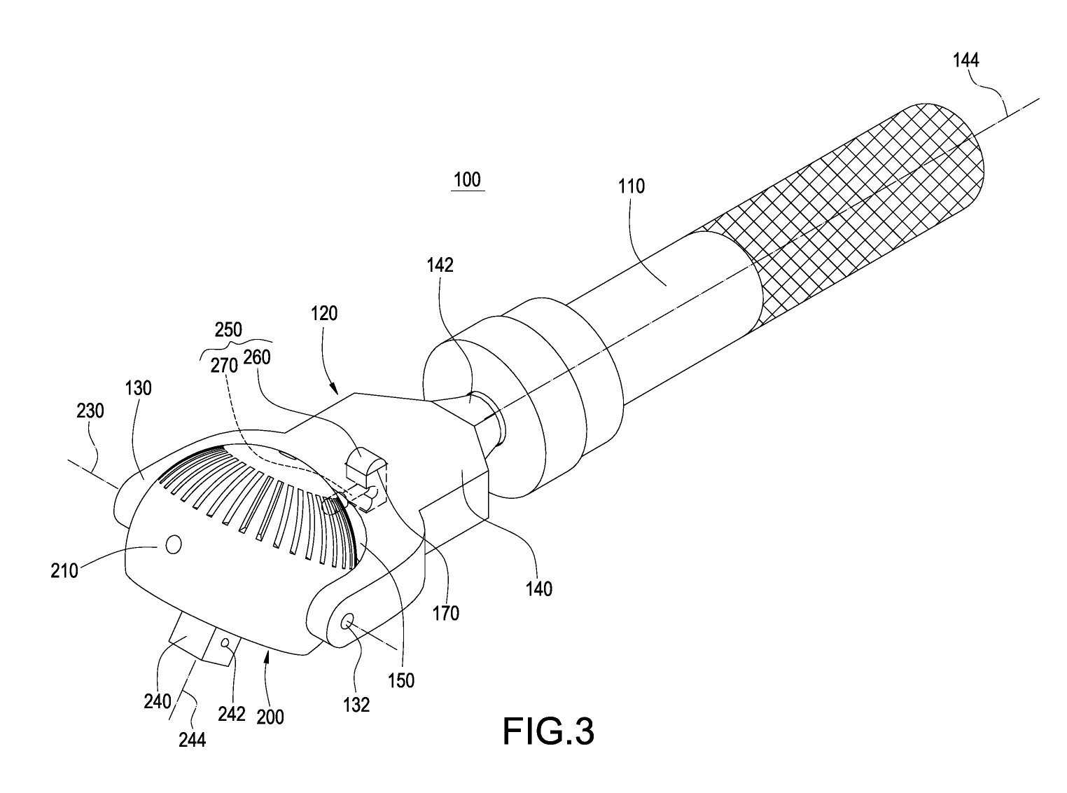

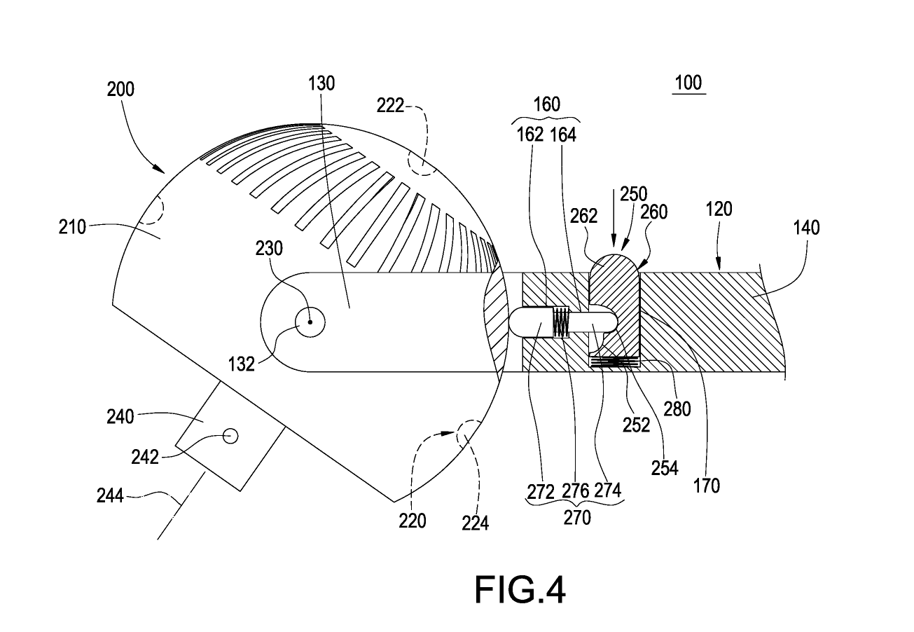

In the present embodiment, the radial hole 170 is preferably a blind hole, one end of the locking spring 280 is connected to a bottom of the locking rod 260, and the other end of the locking spring 280 is in contact with a bottom of the blind hole. When the locking rod 260 radially moves from the locked position (as in FIG. 2) to a released position (as in FIG. 4), the latch bar 270 can be moved to retract from the fork opening 150 to be released from the positioning recess 220. At this point, the locking spring 280 shown in FIGS. 3 and 4 are compressed under the action of a force, and the ratchet wrench 100 is in the released state/position.

One side of the locking rod 260 corresponding to the axial hole 160 includes a locking recess 252 and a release recess 254 adjacent to the locking recess 252. When the locking rod 260 is radially movable in the radial hole 170, the latch bar 270 is allowed to move axially in the axial hole 160. In other words, when the locking rod 260 moves, one end of the latch bar 270 slides to contact the locking recess 252 or the release recess 254. The other end of the latch bar 270 is engaged with or released from any positioning recess 220. A depth of the locking recess 252 is preferably less than a depth of the release recess 254.

The latch bar 270 includes a first bar 272, a second bar 274 connected to the first bar 272, and a compression spring 276 connected to the first bar 272 or the second bar 274. The axial hole 160 of the drive bar 120 includes a first hole 162 and a second hole 164. The first bar 272 is disposed in the first hole 162, and the second bar 274 is disposed in the second hole 164, wherein a diameter of the first bar 272 is larger than a diameter of the second bar 274, so that the compression spring 276 can receive the second bar 274 easily. Moreover, an end portion of the first bar 272 has a shape corresponding to a shape of each of the positioning recesses 220, e.g. an arc shape or other suitable shape, so as to be engaged with each positioning recess 220 correspondingly.

Two ends of the compression spring 276 are preferably connected to the first bar 272 and a bottom end of the first hole 162, so that the latch bar 270 keeps having an elastic force to protrude out toward the fork opening 150. When a button portion 262 of the locking button 250 is pressed, the locking rod 260 moves from the locking recess 252 to the release recess 254, and the latch bar 270 obtain a space for moving to the release recess 254. Consequently, a user can easily and rapidly rotate the rotary head 200 to a desired positioning recess 220. At this moment, the compression spring 276 recoils automatically to be engaged with the positioning recess 220.

In the present embodiment, the locking button 250 can keep a normal close state. The locking rod 260 keeps staying in the locking recess 252 under the action of the locking spring 280, so that the latch bar 270 protrudes out of the axial hole 160 to be engaged with a corresponding one of the positioning recesses 220.

In the embodiment shown in FIGS. 1 and 2, the latch bar 270 of the locking button 250 is preferably engaged with the first positioning recess 222, so that the user can operate the ratchet wrench 100 in its upright state to tighten or loosen the object. That is to say, the central axis 244 of the output element 240 of the rotary head 200 is parallel to the rotation axis 144 of the drive bar 120 for quick rotation operation.

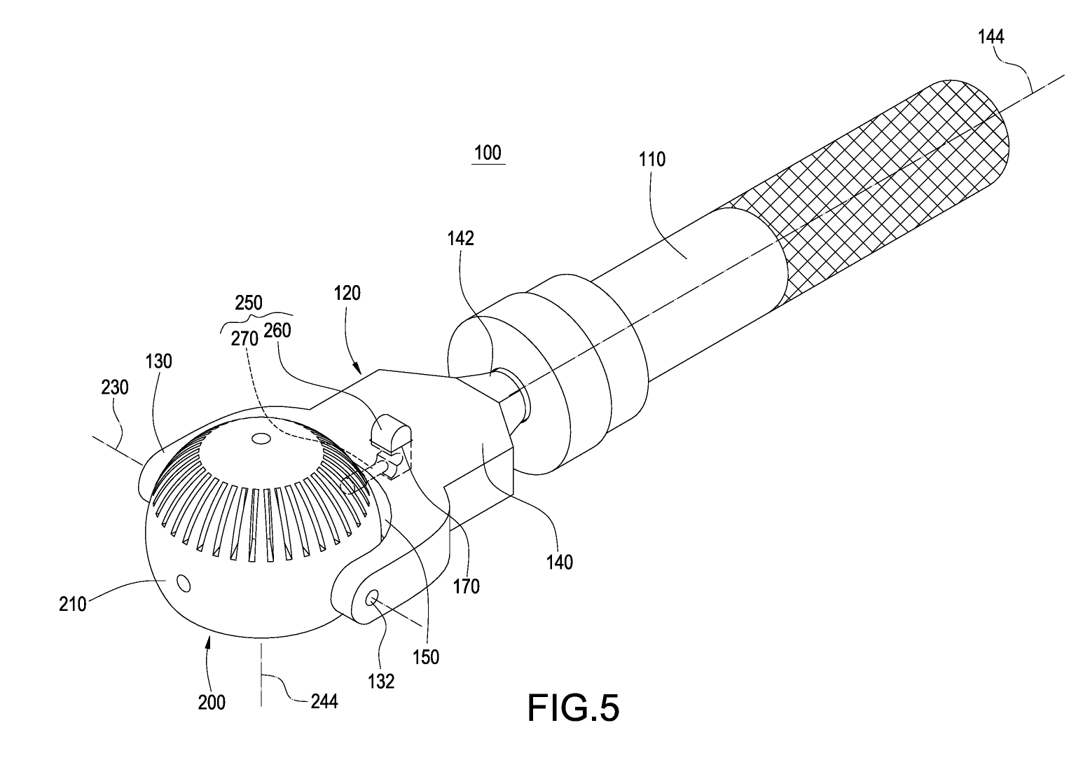

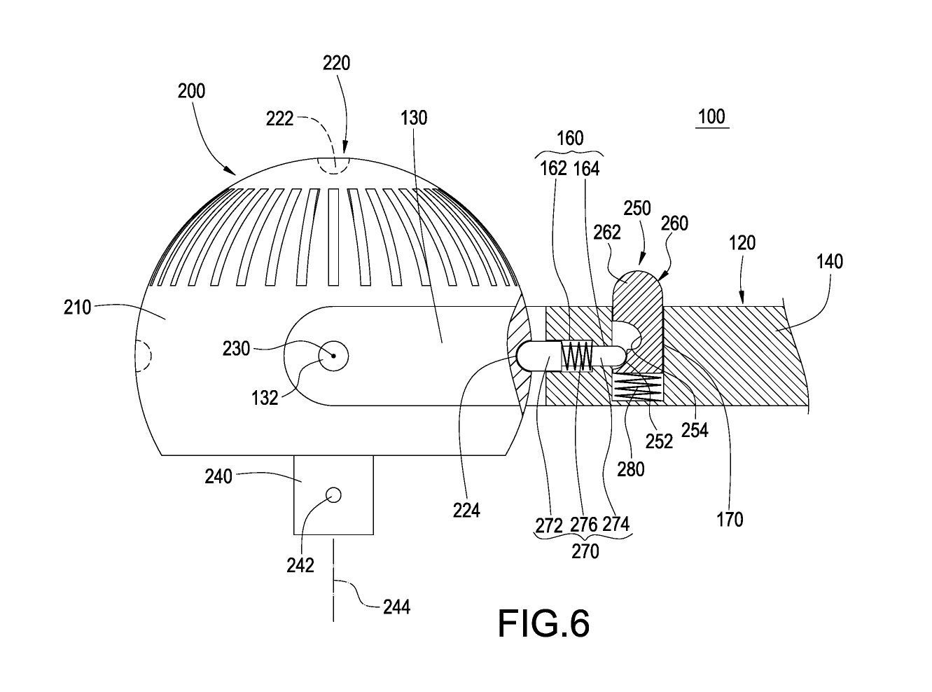

Referring to FIGS. 3 to 6, if in some work environments, the user has to operate the ratchet wrench 100 in its horizontal state or in a similar state. By pressing the locking rod 260 of the locking button 250, the latch bar 270 moves from the locking recess 252 to the release recess 254. At this point, the latch bar 270 is still engaged with the positioning recess 220 under the action of the compression spring 276. When the user rotates the rotary head 200 to the second positioning recess 224 or other suitable positioning recess, the compression spring 276 recoils to make the latch bar 270 automatically return to be engaged with the corresponding positioning recess 220, and then the user can release the locking rod 260. After the user releases the locking rod 260, the locking spring 280 recoils to push the locking rod 260 to move from the release recess 254 to the locking recess 252, so the latch bar 270 can be engaged with the second positioning recess 224 or other corresponding positioning recess 220, so as to fasten the rotary head 200.

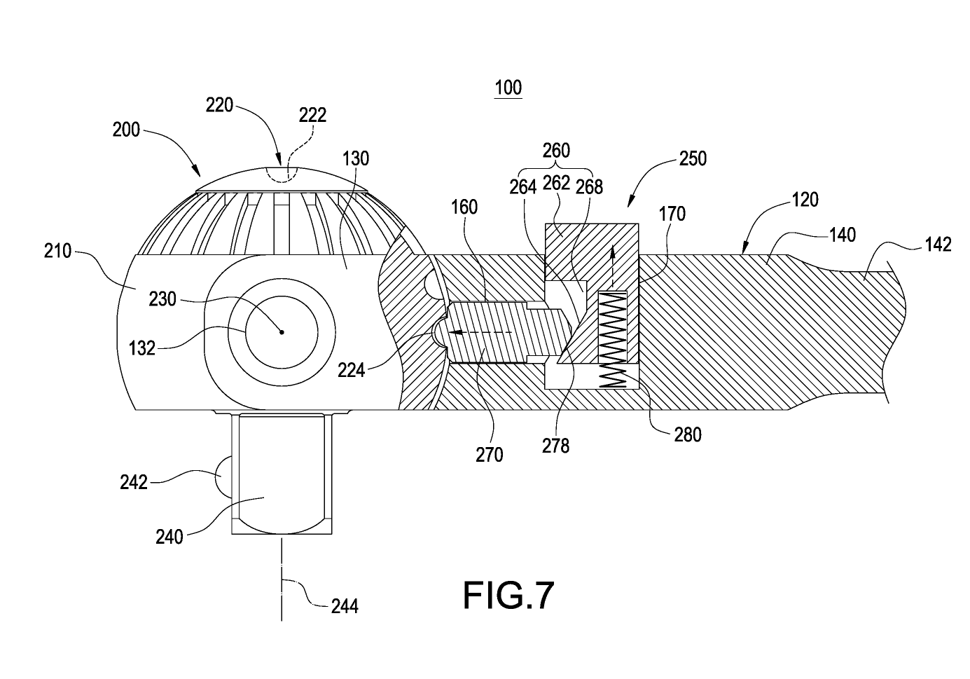

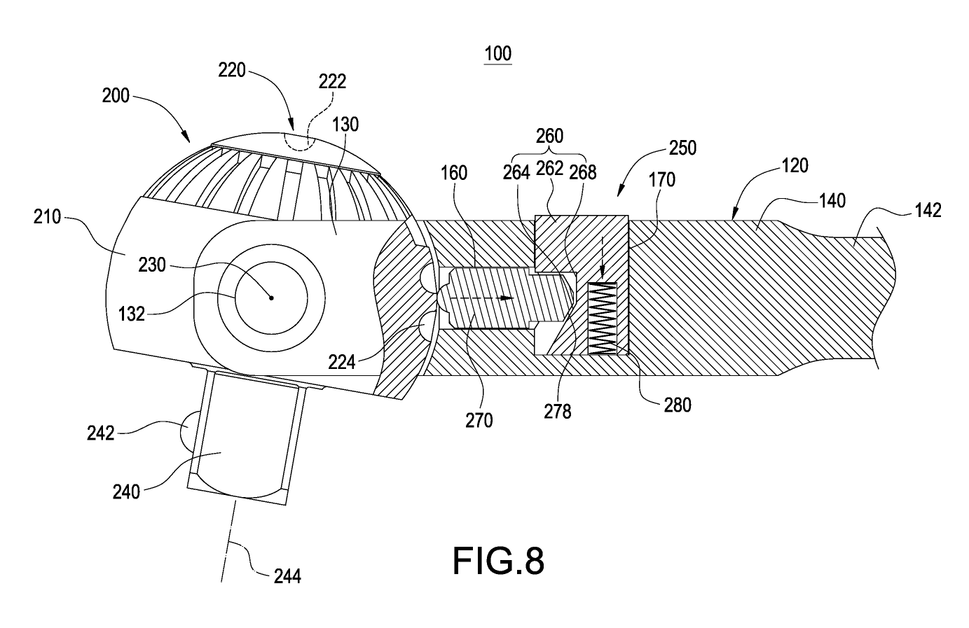

Referring to FIGS. 7 and 8 showing a second embodiment, the second embodiment is different from the first embodiment in that the locking rod 260 and the latch bar 270 have different structures. As shown in the drawings, one side of the locking rod 260 corresponding to the latch bar 270 includes a first inclined surface 264 and a release recess 268 connected to the first inclined surface 264, and the latch bar 270 includes a second inclined surface 278 movable along the first inclined surface 264. The locking rod 260 includes a button portion 262 protruding out of the radial hole 170, so that the user can press the locking button 250 to operate the same easily. The button portion 262 is preferably integrally formed with the locking rod 260. However, in other different embodiment, the button portion 262 can also be a part assembled to the locking rod 260.

When the user presses the button portion 262 of the locking rod 260, the locking rod 260 releases the latch bar 270 and moves relatively to the release recess 268, so the latch bar 270 is axially movable to the release recess 268. As shown in FIG. 8, by the user's rotating the rotary head 200, the round housing 210 or the positioning recess 220 rotatably pushes the latch bar 270, so the latch bar 270 moves toward the bar body 142 until the rotary head 200 is rotated to the desired positioning recess 220. However, in other different embodiment, the compression spring in the foregoing embodiment can be employed to enhance reliability of automatic engagement of the latch bar 270 with the positioning recess 220.

On the contrary, upon the user's releasing the locking rod 260, the locking spring 280 recoils to push the locking rod 260 to an original position (as in FIG. 7). At this moment, the first inclined surface 264 of the locking rod 260 pushes the second inclined surface 278 of the latch bar 270, so the latch bar 270 axially protrudes out of the axial hole 160 to be engaged with the corresponding positioning recess 220.

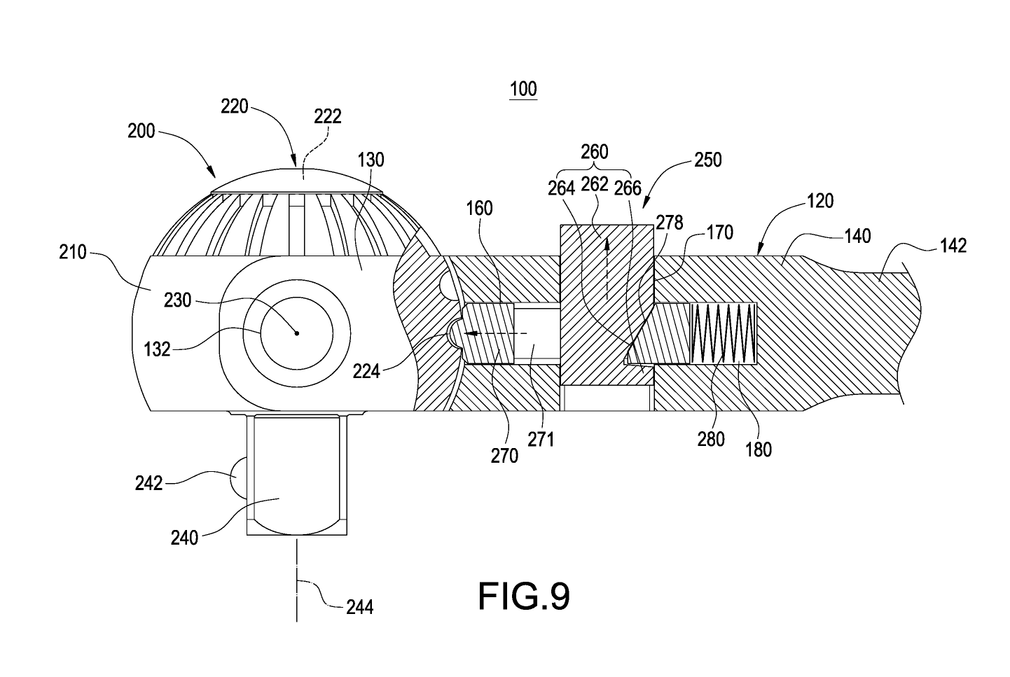

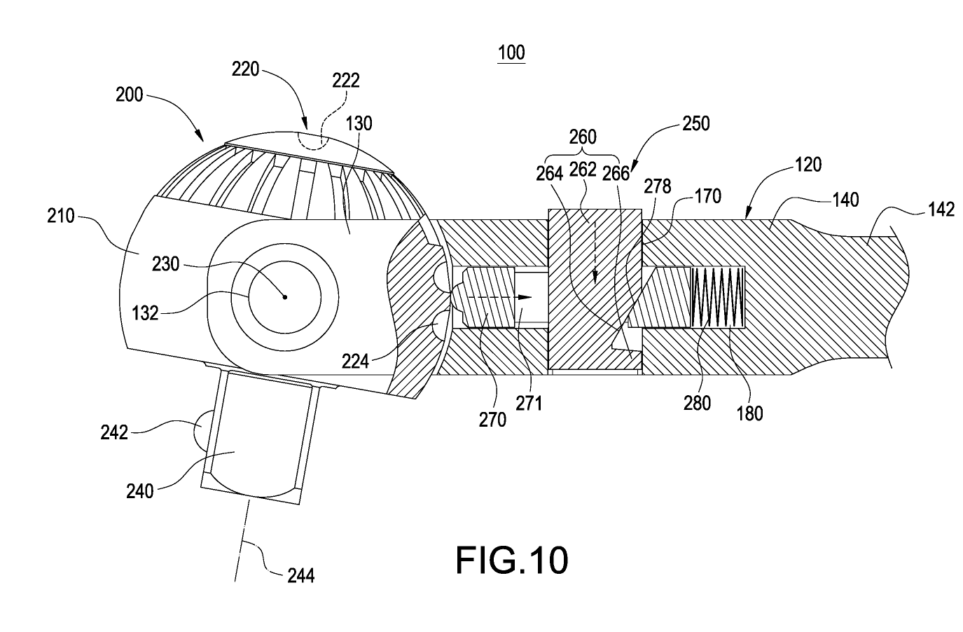

Referring to FIGS. 9 and 10 showing a third embodiment, the third embodiment is different from the previous two embodiments in that the locking spring 280 is disposed in a different place, and the locking rod 260 and the latch bar 270 have different structures. As shown in the drawings, the drive bar 120 includes an accommodating recess 180 in communication with the radial hole 170. The locking spring 280 is disposed in the accommodating recess 180. The radial hole 170 accommodating the locking rod 260 can be a through hole or a blind hole, and the present invention is not limited in this regard. One end of the locking spring 280 is connected to a bottom end of the latch bar 270, and the other end of the locking spring 280 is in contact with a bottom of the accommodating recess 180. The accommodating recess 180 is disposed corresponding to the axial hole 160. The locking spring 280 includes, but not limited to, a compression spring.

The locking rod 260 includes a first inclined surface 264 and a limiting portion 266 adjacent to the first inclined surface 264. The latch bar 270 includes a through hole 271 for insertion of the limiting portion 266 and a second inclined surface 278 movable along the first inclined surface 264. In the present embodiment, when the user presses the button portion 262 of the locking rod 260, the first inclined surface 264 of the locking rod 260 pushes the second inclined surface 278 of the latch bar 270, so the latch bar 270 moves axially toward the accommodating recess 180 until the latch bar 270 is released from the positioning recess 220. A size of the button portion 262 of the locking rod 260 is greater than a size of the latch bar 270, so the latch bar 270 can limit the button portion 262 from keeping moving radially.

As shown in FIG. 10, the user can rotate the rotary head 200 easily until the rotary head 200 is rotated to the desired positioning recess 220. After the user's releasing the locking rod 260, the locking spring 280 recoils and pushes the locking rod 260 to the original position (as shown in FIG. 9). At this moment, the second inclined surface 278 of the latch bar 270 pushes the first inclined surface 264 of the locking rod 260, so that the button portion 262 of the locking rod 260 protrudes out of the radial hole 170. At the same time, the latch bar 270 axially moves to protrude out of the axial hole 160 to be engaged with the corresponding positioning recess 220. Since the limiting portion 266 of the locking rod 260 can be engaged at one side of the latch bar 270, a radial moving distance of the locking rod 260 is limited.

Therefore, the present invention is easy to operate and has a simple structure. By pressing the locking rod 260 of the locking button 250, rotating the rotary head 200 to the desired positioning recess 222, 224, and then releasing the locking button 250, the purpose of quickly fastening the rotary head 200 can be achieved.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. A ratchet wrench having a positioning mechanism, comprising:
a drive bar, the drive bar including a fork arm, a fork opening formed at the fork arm, an axial hole communicating with the fork opening, and a radial hole communicating with the axial hole;
a rotary head, the rotary head being pivotally connected to two ends of the fork arm, the rotary head including a round housing, a ratchet apparatus disposed inside the round housing, a plurality of positioning recesses disposed on the round housing, and a pivot axis formed at the rotary head and passing through the two ends of the fork arm, wherein the pivot axis is perpendicular to the radial hole; and
a locking button, the locking button including a locking rod disposed in the radial hole and a latch bar disposed in the axial hole, the locking rod being radially movable in association with movement of the latch bar, the latch bar being engaged with or disengaged from any of the positioning recesses.

2. The ratchet wrench having the positioning mechanism of claim 1, wherein the locking button includes a locking spring for automatically restoring the locking rod, and the latch bar axially moves at the same time to protrude out of the axial hole.

3. The ratchet wrench having the positioning mechanism of claim 2, wherein the radial hole is a blind hole, one end of the locking spring is connected to an end of the locking rod, and the other end of the locking spring is in contact with a bottom of the blind hole.

4. The ratchet wrench having the positioning mechanism of claim 2, wherein one side of the locking rod corresponding to the latch bar includes a locking recess and a release recess adjacent to the locking recess.

5. The ratchet wrench having the positioning mechanism of claim 2, wherein one side of the locking rod corresponding to the latch bar includes a first inclined surface and a release recess connected to the first inclined surface, and the latch bar includes a second inclined surface movable along the first inclined surface.

6. The ratchet wrench having the positioning mechanism of claim 2, wherein the drive bar includes an accommodating recess communicating with the radial hole, the locking spring is received in the accommodating recess, one end of the locking spring is connected to one end of the latch bar, and the other end of the locking spring is in contact with a bottom of the accommodating recess.

7. The ratchet wrench having the positioning mechanism of claim 4, a depth of the locking recess is less than a depth of the release recess, and an end portion of the latch bar is slidable to contact the locking recess or the release recess.

8. The ratchet wrench having the positioning mechanism of claim 4, wherein the latch bar includes a first bar, a second bar connected to the first bar, and a compression spring connected to the first bar or the second bar, and the axial hole includes a first hole and a second hole communicating with the first hole.

9. The ratchet wrench having the positioning mechanism of claim 1, wherein the locking rod includes a first inclined surface and a limiting portion adjacent to the first inclined surface, the latch bar includes a through hole for insertion of the limiting portion and a second inclined surface movable along the first inclined surface.

10. The ratchet wrench having the positioning mechanism of claim 1, wherein the drive bar includes an enlarged end and a bar body, the enlarged end is disposed between the fork arm and the bar body, and the axial hole and the radial hole are both disposed in the enlarged end.
